(19) United States
(12) Patent Application Publication
(10) Pub. No.: US 2007/0207026 A1
(43) Pub. Date: Sep. 6, 2007

(54) Part-handling device and industrial handler comprising said device

(76) Inventors: Francisco Cortes Grau, Sant Quirce del Valles (Barcelona) (ES); Ramon Casanelles Moix, Sant Quirce del Valles (Barcelona) (ES)

Correspondence Address: PEPPER HAMILTON LLP, ONE MELLON CENTER, 50TH FLOOR, 500 GRANT STREET, PITTSBURGH, PA, 15219, US

(21) Appl. No.: 11/572,183

(22) PCT Filed: Jul. 6, 2005
(86) PCT No.: PCT/ES05/00388

§ 371 Date: Jan. 16, 2007

(30) Foreign Application Priority Data
Jul. 15, 2004 (ES) P200401778

(51) Int. Cl. B66C 3/00

(52) U.S. Cl. 414/729

(57) ABSTRACT

A device for handling a part. The device is configured for coupling to a handler. The device comprises a rigid arm, a support coupled to the rigid arm, a motor mounted on the arm, and a transmission coupled to the motor and the support. The rigid arm is configured to rotate integrally with an end element of the handler when the rigid arm is coupled to the handier. The support is turnable relative to the rigid arm, and the support is configured for coupling, to a gripping element. The motor is configured for actuating turning of the support relative to the rigid arm.

### CROSS-REFERENCE TO RELATED APPLICATIONS

This patent application is the national stage of, and claims priority to, International Patent Application PCT/ES2005/000388 with an International Filing Date of Jul. 6, 2005. This application, through the International Application, also claims priority to Spain Patent Application Number ES200401778 with a Filing Date of Jul. 15, 2004. The disclosures of each of the aforementioned patent documents are incorporated herein by reference in their entirety.

Not applicable.

### BACKGROUND

Currently, various types of industrial handlers are known to be used in a broad range of applications.

For example, it is common to use robots and other handlers on press lines used to manufacture vehicle bodywork parts: the handlers are responsible for loading and unloading the parts between one press and another, a store room and a press, etc.

One type of handler which is frequently used because of its ability to adapt to a great variety of different movements and cycles, is articulated robots, for example robots with four to six degrees of freedom, each degree of freedom is an independent movement (turn or displacement) that one articulation can make with respect to the preceding one.

Another type of handler used on press lines are the so-called “Doppins,” which generally consist of a structure attached to the press and equipped with a guide on which a cart travels vertically; the cart is fitted with a system of articulated arms, which is responsible for the movement of entering and exiting the press for loading or unloading parts.

On all handlers, an end element is installed on the system's free end, which in the case of press maintenance is a gripping element adapted to the parts to be loaded and unloaded, this gripping element is usually called a “gripper,” and can use either a mechanical, electromagnetic or vacuum gripping system, depending on each case's specific requirements.

There may be different handling configuration between on station and another of a press line; for example, a single handler that extracts the part from one station and introduces it into another one, or a pair of handlers, one for unloading from on station and another one for loading it onto the following station, with or without the interposition of conveyor belts, rotatory mechanisms, etc.

In all cases, on press lines, as in most industrial operations, it is advisable to minimize cycle times: where handlers are concerned, an important part of the cycle is the extraction or insertion of the part in relation to the press's area of influence, since during this phase the press must remain open, and therefore, inactive; consequently, it is advisable to extract and insert the part quickly.

What follows is a discussion of this problem, by way of example, with reference to an articulated robot that extracts a part from one press and inserts it into the following one.

There are basically two cycles that an articulated six-axis robot, with a gripper attached to its sixth axis, can perform for this operation.

In one cycle, usually called the “external” cycle, the robot first extracts the gripper holding the part from the press following a rectilinear trajectory in parallel to the press line, through combined turns around the first three aces; secondly, it makes the tripper turn with regard to the 4^{th} and 6^{th} axes to leave it facing the following press; and finally, it inserts the part into the press following a rectilinear trajectory.

The advantage of this type of cycle is that the partial extraction and insertion times are relatively short, because the movements are linear; however, the overall cycle time is fairly long

In an alternative cycle, usually called an “internal” cycle, which can be seen in FIG. 1, the robot maintains its arm extended and through simultaneous turn with regard to the 1^{th} and 6^{th} axes makes the gripper with the part perform a single movement with a trajectory, essentially horizontal, which occurs between the 6^{th} axis and the base of the robot; however, due to the rotation around the 6^{th} axis, the part turns during the extraction and the insertion in the presses.

The overall cycle time in this case is relatively small, due to the fact that the robot performs a single movement; however, the partial extraction and insertion times for the parts are high, because the part's turn makes a section of it remain longer under the press. Another inconvenience of turning the pare during the extraction and the insertion in the presses is that the obstacles represented by the press columns themselves must be taken into account, which can make the gripper's turning with the part difficult.

For certain, conventional solutions for loading and unloading from presses present limitations when it comes to in reducing cycle times.

Moreover, in both cases, the part is turned 180° when passing from one press to another.

In recent years, some devices or accessories have been proposed intended to be coupled with the 6^{th} axis of an articulated robot, which partially resolve these problems.

European patent application EP666150A1 describes a mechanism that is coupled to the robot's wrist and displaces the turn of the 6^{th} axis to the end of a rigid bar. This mechanism makes it possible to maintain the part's orientation as it passes from one press to another, and makes a linear extraction and insertion movement; however, the robot is forced to retract considerably for this movement, which makes it fairly slow, especially if the distance between presses is large. Another inconvenience of this mechanism is that, due to the act that there is no possibility of turn around the robot's 6^{th} axis, to enter the press laterally the bar must be fairly long, and this causes problems of weight, rigidity and similar.

Another known device includes two bars articulated to each other by their ends; a first bar is coupled by its other end to the robot's 6^{th} axis, while the other end of the second bar is coupled to the gripper for the part to be handled. There is a motor on the articulation between the two bars which makes it possible to action the gripper's rotation in relation to the second bar.

This system makes it possible to transfer the part with an internal turn, such as the one represented in FIG. 1, but with linear extraction and insertion into the presses, since the combination of rotations around the different axes makes it possible to rotate the gripper holding the part in the opposite sense to the robot arm's turn during the phases of extraction or insertion, thus maintaining the part's orientation, and performing an approximately linear movement between one press and another.

Nonetheless, this system is relatively complex, because it implies two bars articulated to each other, with the ensuing inconveniences concerning the assembly's rigidity.

At the same time, and irrespective of the robot's movements, it is also advisable to ensure that the gripper is of limited height, in order to be able to partially overlap the press's opening and closing movements with the part's insertion and extraction; and it is also desirable, in terms of safety and savings, that the gripper and any other part of the handler which penetrates within the press's area of influence are made of light low-hardness materials, compatible with their function, in order to minimize as much as possible any damage to the press in the event of an accident.

In the described system with two articulated bars, the rigidity requirements make it difficult to reduce the height of the assembly; moreover, the articulation with the motor penetrates within the significant damage in the event of an accident.

### SUMMARY

The present invention relates to a device used to handle parts, for example for loading and unloading parts onto a press line. The device is intended to be coupled to an industrial handler, such as an articulated robot, that presents a kinematic chain between a base and an end element.

The purpose of the present invention is to reduce the inconveniences of the technique described above, by providing means to minimize the partial extraction and insertion times from the press without increasing the overall cycle times, in a technically advantageous manner in terms of safety and reliability.

In line with this objective, in a first aspect, this invention relates to a device used for handling parts, intended to be coupled to an industrial handler that presents a kinematic chain between a base and an end element, characterized in that that it comprises a rigid arm, which is designed to be linked to the handler's end element; a support which is mounted to the rigid arm so that it can move and which is designed to be rigidly coupled to an element for gripping the parts to be handled; and means for actuating the movement of the support in relation to the arm.

The device's characteristics make it possible to provide the handler with an additional degree of freedom, through which the parts can be extracted and inserted into work stations, such as presses, with a linear movement, and consequently in a reduced time, in a manner also compatible with a reduced overall time; moreover, this is done in a mechanically simple and reliable ways with the possibility of avoiding the penetration of very hard or voluminous parts inside the work stations.

Preferably, the rigid arm is designed to rotate in unison with the handler's end element; in this way, the arm can remain parallel to the line that joints the presses during the handler's turning movement from one press to another.

In a first embodiment, the support is mounted to the rigid arm allowing a rotational movement.

The support's turn with respect to the arm makes it possible for the gripper holding the part to maintain its orientation during the turn of the handlers end element.

In this embodiment, the rigid arm may be coupled on one end to the handler's end element, and the support mounted to the opposite end of the arm such that it can turn; the axis of rotation of the support with respect to the arm is preferably parallel to the axis of rotation of the handler's end element,

The means for actuating the support's movement advantageously comprise a motor mounted on the arm, near the arm's coupling with the handler's end element; the device may additionally comprise a transmission throughout the arm's length, between the actuating motor and the support.

The motor's installation near the handler prevents it from penetrating under the press's zone of influence.

In accordance with a second embodiment, the support mounted to the rigid arm can travel along it. In this way, the support can perform a movement adapted to the linear extraction or insertion of the parts in the presses.

Advantageously, the rigid arm can travel linearly with respect to the handler's end element. In this way, the part's absolute displacement is faster.

In this embodiment, the device preferably comprises a guide element, coupled to the rigid arm, with the possibility of sliding, with said guide element intended to be mounted such that it rotates in unison with the handler's end element.

The guide element interposed between the handler and the rigid arm enables a combination of movements which results in the displacement of the arm in parallel to the line joining the presses, at a greater speed than the one provided by the handler.

The means for actuating the support's movement may comprise, in one embodiment, a transmission that from a motor actuates both the support in relation to the arm and the arm in relation to the guide element; advantageously, the transmission acts in such a way that the relative speed of displacement of the arm in relation to the guide element is the same as the relative speed of displacement of the support in relation to the arm.

Due to these characteristics, the support moves the part from one end of the arm to the other while the latter moves in relation to the handler's end element, in such a way that the speed of the par is the sum of speeds of the different elements.

In this embodiment, the motor is preferably designed to be attached to the handler; in this way, the displacements of the arm and support are not hindered.

The invention also refers to an industrial handler which presents a kinematic chain between a base and an end element, characterized in that that it comprises a device of the type described above, linked to said end element.

Preferably, the handler comprises an articulated robot of at least two axes.

### BRIEF DESCRIPTION OF THE DRAWINGS

To contribute to a better understanding of what has been described, we enclose some drawings which, schematically and only by way of a non-restrictive illustration, represent a practical embodiment of the invention.

In the drawings:

FIG. 1 is a schematic plan view of a handler in accordance with the prior art, ready to transfer a part between two presses;

FIG. 2 is a perspective plan view of a device in accordance with a first embodiment of the invention,

FIG. 3 is a scheme showing the movement of a handler with the device of FIG. 2;

FIG. 4 is an elevation schematic view of a device in accordance with a second embodiment of the present invention; and

FIG. 5 is a schematic plan view showing the movement of a handler with the device of FIG. 4.

### DETAILED DESCRIPTION

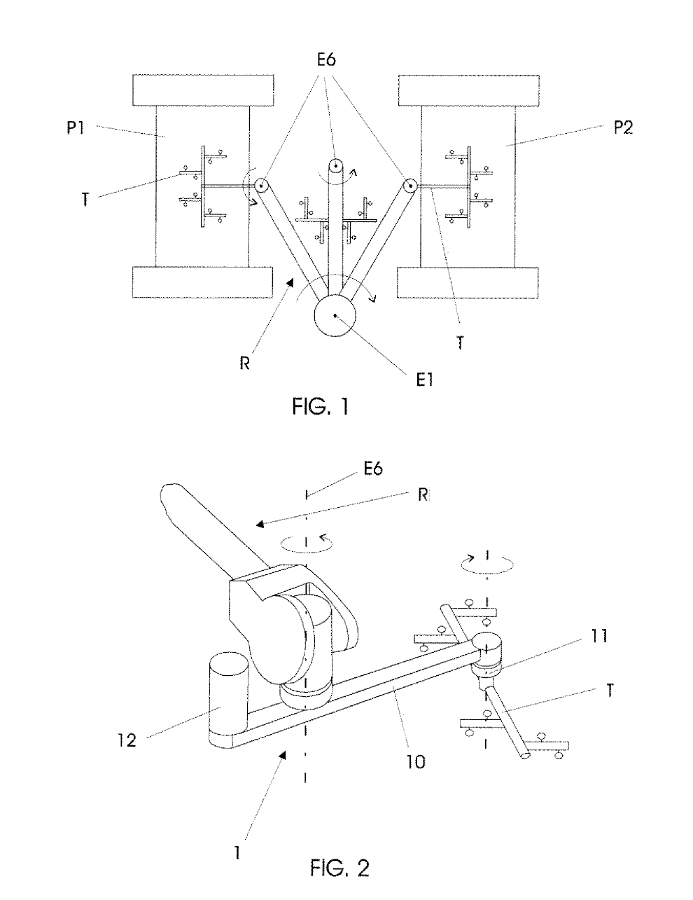

FIG. 1 represents the state of the art and shows a plan view of two presses P1 and P2, between which a part must be transferred (not shown) using a robot R, for example a six-axis articulated robot such as the one described in patent application EP666150A1.

A handler, such as the articulated robot of FIG. 1, presents a kinematic chain with various degrees of freedom between a stationary base and an end element; the end element may be a turning axis, a body with a degree of freedom of linear displacement, etc.

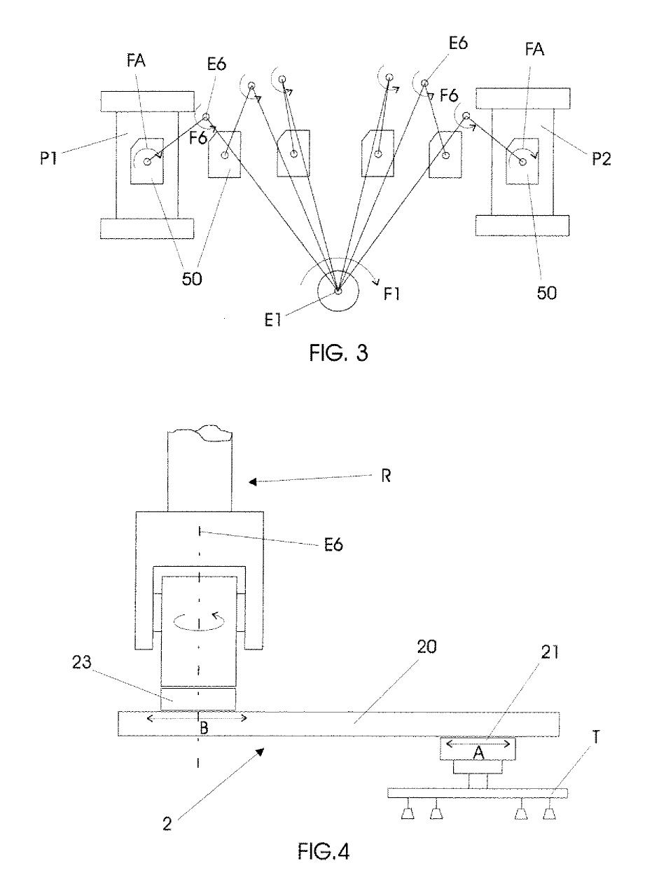

FIG. 3 shows in a very schematic manner, only the characteristics of robot R which are necessary to understand the movement between the presses; for a more detailed description of the structure of a robot of this type, it is possible to refer, for example, to the cited patent application.

As can be seen from FIG. 1, which shows three successive positions of robot R, conventionally a gripping end element T is coupled to the sixth axis of robot R which in this case is a gripper with a vacuum gripping system to hold the part to be transferred.

An ‘internal’ type movement to transfer the part from press P1 to P2, is performed as follows. On the left of the figure, the gripper T is in the position of picking the part from press P1; next, through simultaneous turns, around the first axis, E1 and the sixth axis E6, in the senses indicated by the figure's arrows, the robot makes the gripper turn following a trajectory, essentially horizontal, which is between the sixth axis and the base of the robot. In the position shown on the right of FIG. 1, the robot has completed the movement and the tripper releases the part, in a position that is turned 180°, on press P2.

As already mentioned, with this conventional movement there is the inconvenience of the part turning when it leaves one press and it enters the next one, in such a way that the time that the press must remain open is relatively long.

To reduce this inconvenience, in accordance with an embodiment of the invention, the auxiliary device 1 shown in the scheme of FIG. 2 is coupled to the robot's sixth axis: in this embodiment, the auxiliary device 1 comprises a rigid arm 10, which is fixed in rotation to the E6 axis of the robot, near one of its ends, and presents on the opposite end a turning support 1, designed to be coupled to the end element T.

Support 11 can turn with respect to arm 10 actuated by a motor 12 that can be mounted on the arm 10 itself preferably as shown in FIG. 2, near the end of the robot's sixth axis E6. The rotation of motor 12 is transmitted throughout the length of the arm to the support 11 by means of any suitable type of transmission (not shown), for example, a cogged belt, bar or endless screw.

In this way, the robot is provided with an additional degree of freedom or “seventh axis,” actuated independently of the sixth axis E6.

Due to this “seventh axis,” with device 1 coupled to the sixth axis E6 of a robot in the situation of FIG. 1 it is possible to transfer a part between the two presses with a turn of the “internal” type and linear extraction and insertion in the presses, as explained below with reference to FIG. 3; this figure shows different positions of the movement of a robot R fitted with the device of FIG. 2, which transfers a part 50.

On the left of FIG. 3 the robot is shown in the position of picking the part 50 from press P1. In the extraction movement, axes E1 and E6 of the robot turn as shown by the arrows F1 and F6, respectively, in a similar manner as described for FIG. 1, in addition, on device 1, the support 11 that holds the gripper with the part 50 turns in the sense indicated by the arrow FA synchronized with the turn of the axis E6, in such a way that this turn FA of the support 11 compensates the turn of the axis E6 and as a combination of the two rotations the part does not turn in relation to the presses, but rather is transferred in parallel to the line that joins the two presses.

Consequently, the extraction of the part from the press P1 is linear, and the extraction time is less than in the case of FIG. 1.

The insertion of the part in press P2 is done in an analogous manner, with a linear movement of the part 50 due to the turn FA of the support 11 which compensates the turn of the axis E6. Consequently, the time for inserting the part into the press is less than in the case of FIG. 1.

Additionally, part 50 is inserted in press P2 with the same orientation as it had in press P1; in other words, as opposed to what occurred in FIG. 1, the part is not left turned

We should also note that the arm 10, which must travel the space beneath the press, can be made of materials of relatively low hardness, such as aluminum and at the same time be sufficiently rigid, without having to have a height that impedes or hinders overlapping the presses' opening and closing with the maneuvers for extracting and inserting the part, because it has no intermediate articulation; for its part, the motor is maintained at all times outside of the press.

FIG. 4 shows a second embodiment of a device in accordance with the invention.

In this figure, the auxiliary device 2 comprises a rigid arm 20, in relation to which the support 21, intended to hold the gripper or end element T, can travel. A motor (not shown) makes it possible to displace the support throughout the length of arm 20, as shown by arrow A.

The arm 20 is liked to the sixth axis E6 of the robot in such a way that it can turn in unison with said axis and can also travel in relation to it, for this purpose, it has a guide element 23 coupled in rotation to the axis E6 in relation to which the arm 20 can travel as shown by arrow B. Actuating the arm's movement throughout the guide element 23 can be done from the same motor which moves the support 21, with the appropriate transmission.

By adding the device of FIG. 4 to a robot such as the one of FIG. 1 also achieves a combination of linear extraction and insertion trajectories, provided in this case by the displacement of the arm 20 in relation to the sixth axis and the displacement of the support 21 in relation to the arm 20, with a reduced overall cycle time.

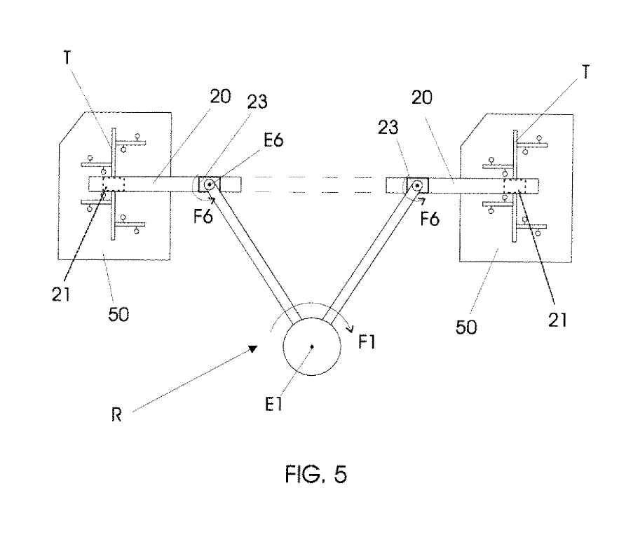

FIG. 5 shows the two end positions of an operation to transfer a part 50 from one press to another with a robot which has coupled to its sixth axis E6 a device such as the one of FIG. 4.

On the left of FIG. 5 the robot is shown in the position of picking the part 50 from one press. In the extraction movement, the robot's axes E1 and E6 turn as indicated by arrows F1 and F6, in such a way that the arm 20 of device 2 maintains its orientation; additionally, on device 2, the support 21 which holds the gripper T travels to the right along the length of arm 20, and at the same time the arm 20 travels towards the right with respect to axis E6. Consequently, the part 50 is extracted from the press in a linear fashion.

When the robot completes its turn around the axis E1 (position represented on the right of FIG. 5), the arm 20 has traveled in such a way that the E6 axis has passed from one end to the other end of it, and the support 21 with the gripper T has also reached the opposite end of the arm 20, and loading of part 50 on the next press has also been performed in a linear manner.

Also in this case, the entry of motors and other hard elements into the presses zone of influence has been prevented, although the height of arm 20 will be in general superior to the one of arm 10 of the device of FIG. 2; and the orientation of part 50 has also been maintained.

We should highlight that all of the constructive details of the described devices, such as materials, transmissions, motors and similar may be of any type, depending on the specific requirements of each case, and that the expert in the matter may substitute the described technical elements with other equivalent ones without abandoning the scope of protection defined by the enclosed claims.

Likewise, it is evident that the devices in accordance with the invention and the handlers to which they are coupled may incorporate any other elements appropriate to their functioning such as may be sensors, control and synchronization elements, etc.

In the examples contained in this description, we have described devices coupled to the sixth axis of an articulated six-axis robot; however, clearly any other robot, such as a four-axis or two-axis robot, is appropriate for the coupling of a device in accordance with the invention.

In the same way, the devices may be associated to handlers that work, as in the preceding figures, on loading and unloading between two stations, but also to handlers only for loading or only for unloading, or to handlers that work between a press and a store room, etc.

At the same time, some devices in accordance with the invention may be coupled to another type of handler for loading and unloading parts on presses whose end element is not a turning axis, but has a linear displacement: in the case of a device such as the one shown in FIG. 4, the guide element 23 would couple to the end element of the handler's kinematic chain, and a greater speed of extraction or insertion of the part in the press would be achieved.

Finally, we should mention that the described devices may be used not only for loading and/or unloading operations in presses, but also for any other operation with handlers which have compatible characteristics.

1-15. (canceled)

16. A device for handling a part, the device configured for coupling to a handler, the device comprising:
a rigid arm, wherein the rigid arm is configured to rotate integrally with an end element of the handler when the rigid arm is coupled to the handler;
a support coupled to the rigid arm, wherein the support is turnable relative to the rigid arm, and wherein the support is configured for coupling to a gripping element;
a motor mounted on the rigid arm, wherein the motor is configured for actuating turning of the support relative to the rigid arm; and
a transmission coupled to the motor and the support.

17. The device of claim 16, wherein the transmission comprises one of the following:
a cogged belt;
a bar; and
an endless screw.

18. A device for handling a part, the device configured for coupling to a handler, the device comprising:
a guide element, wherein the guide element is configured to rotate integrally with an end element of the handler when the guide element is coupled to the handler;
a rigid arm coupled to the guide element, wherein the guide element is movable along a length of the rigid arm;
a support coupled to the rigid arm, wherein the support is movable along the length of the rigid arm, and wherein the support is configured for coupling to a gripping element;
a motor mounted on the rigid arm, wherein the motor is configured for actuating movement of the guide element and the support along the length of the rigid arm; and
a transmission coupled to the motor, the guide element, and the support.

19. The device of claim 18, wherein the transmission comprises one of the following:
a cogged belt;
a bar; and
an endless screw.

20. The device of claim 18, wherein the transmission is configured such that a speed of the movement of the guide element along the length of the rigid arm is the same as a speed of the movement of the support along the rigid guide.

21. A handler, comprising:
a rotatable end element.
a rigid arm coupled to the end element, wherein the rigid arm is configured to rotate integrally with the end element,
a support coupled to the rigid arm, wherein the support is turnable relative to the rigid arm, and wherein the support is configured for coupling to a gripping element;
a motor mounted on the rigid arm, wherein the motor is configured for actuating turning of the support relative to the rigid arm; and
a transmission coupled to the motor and the support.

22. The handler of claim 21 wherein the handler further comprises means for turning the support and rotating the end element such that the gripping element, when coupled to the support, does not turn when being moved from a first position to a second position.

23. The handler of claim 21, wherein an axis of rotation of the support relative to the rigid arm is parallel to an axis of rotation of the end element.

24. The handler of claim 21, wherein the handler is an articulated robot of at least two axes.

25. The handler of claim 21, wherein the handler is an articulated robot of four axes.

26. The handler of claim 21, wherein the handler is an articulated robot of six axes.

27. A handler, comprising:
a rotatable end element;
a guide element coupled to the end element, wherein the guide element is configured to rotate integrally with the end element:
a rigid arm coupled to the guide element, wherein the guide element is movable along a length of the rigid am;
a support coupled to the rigid arm, wherein the support is movable along the length of the rigid arm, and wherein the support is configured for coupling to a gripping element,
a motor mounted on the rigid arm, wherein the motor is configured for actuating movement of the guide element and the support along the length of the rigid arm and
a transmission coupled to the motor, the guide element, and the support.

28. The handler of claim 27, wherein the handler further comprises means for rotating the end element, moving the guide element along the length of the rigid arm, and moving the support along the length of the arm such that the gripping element, when coupled to the support, does not turn when being moved from a first position to a second position.

29. The handler of claim 27, wherein the handler is an articulated robot of at least two axes.

30. The handler of claim 27, wherein the handler is an articulated robot of four axes.

31. The handler of claim 27, wherein the handler is an articulated robot of six axes.
